(19) United States
(12) Patent Application Publication
(10) Pub. No.: US 2020/0167707 A1
(43) Pub. Date: May 28, 2020

(54) SYSTEM AND METHOD FOR WORKLOAD FORECASTING AND DISTRIBUTION

(71) Applicant: Perry + Currier Inc., Toronto (CA)

(72) Inventors: Robert COTRAN, Montreal (CA); Christina S. Lee, Toronto (CA); Thomas Andrew CURRIER, Toronto (CA)

(21) Appl. No.: 16/633,891

(22) PCT Filed: Jul. 25, 2018
(86) PCT No.: PCT/IB2018/055564

§ 371 Date: Jan. 24, 2020

Related U.S. Application Data
(60) Provisional application No. 62/536,572, filed on Jul. 25, 2017.

(51) Int. Cl. G06Q 10/06

(52) U.S. Cl. CPC G06Q 10/06315; G06Q 10/107

(57) ABSTRACT

A system and method for workload forecasting and distribution is provided. The method includes obtaining, from a docketing database of the docketing system, active term data defining active terms. The active terms represent action items in the docketing system. The method further includes selecting a subset of the active terms based on the active term data. The method further includes obtaining, from the docketing database, price data associated with the active terms in the subset. The price data represents a cost of performing the action items associated with the active terms. The method further includes generating a predicted cost total based on the price data. The method further includes outputting the predicted cost total.

### CROSS-REFERENCE TO RELATED APPLICATIONS

This application claims priority from U.S. provisional application No. 62/536572, filed Jul. 25, 2017, the content of which is incorporated herein by reference.

### FIELD

The specification relates generally to docketing systems, and specifically to a method and system for workload forecasting and distribution in docketing systems.

### BACKGROUND

Docketing systems provide ways of tracking the assignment of tasks within an enterprise amongst personnel. However, conventional systems generally permit only retroactive assessment of workload distribution and production levels, with any forecasts produced being based on such retroactive assessments. Deployment of resources in such enterprises may therefore be inefficient as a result of inaccurate forecasting data.

### SUMMARY

An aspect of the specification provides a method in a processor of a docketing system. The method includes obtaining, from a docketing database of the docketing system, active term data defining active terms. The active terms represent action items in the docketing system. The method further includes selecting a subset of the active terms based on the active term data. The method further includes obtaining, from the docketing database, price data associated with the active terms in the subset. The price data represents a cost of performing the action items associated with the active terms. The method further includes generating a predicted cost total based on the price data. The method further includes outputting the predicted cost total.

### BRIEF DESCRIPTIONS OF THE DRAWINGS

Embodiments are described with reference to the following figures, in which:

FIG. 1 depicts an example docketing system;

FIG. 2 depicts certain internal components of a control application in the docketing system of FIG. 1;

FIG. 3 depicts a method of workload forecasting in the system of FIG. 1; and

FIG. 4 depicts a method of workload distribution in the system of FIG. 1.

### DETAILED DESCRIPTION

To forecast and distribute workloads, users rely on previous trends and historical data. For example, a user may forecast earnings for a future month based on earnings in a previous month, and/or earnings in the same month of a previous year. This manner of forecasting is inaccurate and subject to highly variable demand. To distribute workload, users rely on individuals estimating their own workload. In particular in industries where individuals run their own practices (e.g. professional services or the like), work is highly siloed, with no centralization or view into others' practices. Individuals may be overworked or underworked without seeking redistribution of work due to the lack of centralized insight.

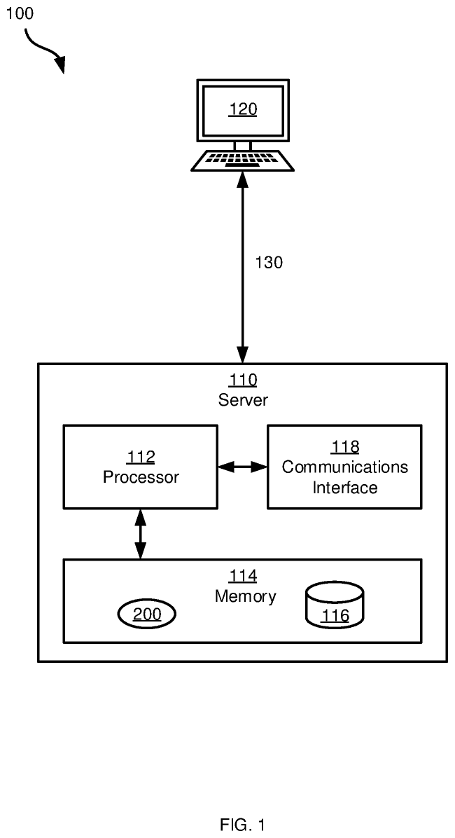

FIG. 1 depicts a docketing system 100 in accordance with the present disclosure. The system 100 includes a server 110 in communication with at least one client device 120 via communication links 130.

The server 110 includes a processor 112, specifically configured to forecast and distribute work. The processor 112 can include a central-processing unit (CPU), a microcontroller, a microprocessor, a processing core, a field-programmable gate array (FPGA), or similar. The processor 112 can include multiple cooperating processors. The processor 112 can cooperate with a non-transitory computer readable medium such as a memory 114 to execute instructions to realize the functionality discussed herein. The memory can include a combination of volatile (e.g. Random Access Memory or RAM) and non-volatile memory (e.g. read only memory or ROM, Electrically Erasable Programmable Read Only memory or EEPROM, flash memory). All or some of the memory 114 can be integrated with the processor 112. The memory 114 stores computer readable instructions for execution by the processor 112.

In particular, the memory 114 stores a plurality of applications, each including a plurality of computer-readable instructions executable by the processor 112. The execution of the instructions by the processor 112 configures the server 110 to perform various actions discussed herein. The applications stored in the memory 114 include a control application 200 which may also be implemented as a suite of logically distinct applications. In general, via execution of the control application 200 or subcomponents thereof, the processor 112 is configured to implement various functionalities. The memory 114 also stores a docketing database 116 (also referred to herein as simply database 116) for tracking information pertaining to matters in the docketing system.

For example, the docketing database 116 can include case information defining a specific matter, such as a patent application, in the system 100 for tracking the status of the matter. Case information, in turn, can include attributes such as a case ID, contact information, country, case type (e.g. patents, trademark, etc.), team information and the like. Case information can also include log items, such as an active term log for tracking completion of an action item.

In some examples, case information can further include financial attributes, such as a charge line. A charge line is stored in connection with a specific case, and can include a line identifier, a work code identifier to identify the action item associated with the charge line, a price, number of units, a description and the like. For example, a charge line can be a tariff associated with completing an action item on the matter, and can be added based on active term and term definition properties, which are described in greater detail below. In other examples, a charge line can be a time charge logged by a team member working towards completing the action item.

The action items for a matter are defined by active terms. Active terms are stored in connection with a specific case/matter in the docketing database 116. The active term may be defined by attributes such as an active term identifier, a term date indicating the deadline for completing the action, an assigned login ID to identify a team member responsible for completing the action item, a case identifier indicating which case the active term is associated with, and the like. Active terms can also include editable fields, such as a completion indicator for updating by a user of the docketing system. For example, the completion indicator may be a percentage value from 0% to 100% of the status of the action item. In other examples, the completion indicator can include a number of hours (e.g. as a decimal value) of work performed towards completing the action item.

The active terms associated with a specific case can be defined based on various term definitions. The term definitions can include a term ID, text describing the action to be completed, a work code identifier for identifying a work code corresponding to the term, other rules to define term properties, and the like. Term definitions can further include a list of related terms representing, for example, subtasks associated with the action item.

The active terms may thus be associated with work codes defined by various work code definitions. The work code definitions can include a work code identifier, a text description, a tariff, and the like. In some examples, the tariff associated with the work code can be based on case information, such as the country and case type, to allow different prices to be listed, for example in different countries. In other examples, the work code definitions can include a time value representing an average or maximum amount of time for completing an action item. More generally, the work code definition defines a quantitative value representing the cost of completing the action item associated with the work code.

For example, a case may be directed to obtaining a patent for a client. The case can include an active term representing an action item to complete the filing of a patent application. The term definition may define related terms defining subtasks associated with filing the patent application, such as drafting the patent application, obtaining approval of the draft patent application, obtaining executed formal documents (e.g. inventorship declarations) associated with the patent application, and the like. The active term can further be associated with a work code specifying a cost for completing the filing of the patent application. As subtasks are complete, indicators of completed work can be associated with the active term. For example, a charge line representing a tariff, or an amount of time spent drafting can be registered. In other examples, an editable field can be updated with a percentage completion of the draft application.

The server 110 also includes a communications interface 118 interconnected with the processor 112. The communications interface 118 includes suitable hardware (e.g. transmitters, receivers, network interface controllers and the like) allowing the server 110 to communicate with other computing devices such as the client device 120, via the communication link 130. The specific components of the communications interface 118 are selected based on the type of network or other links that the server 110 is required communicate over.

The client device 120 can be a computing device such as a desktop computer, a laptop computer, another server, a kiosk, a monitor, or other suitable device. In other examples, the client device 120 includes mobile computing devices, such as a tablet, smart phone or the like. In some examples, the system 100 can include a plurality of client devices 120, each in communication with the server 110 via respective communication links 130.

The communication links 130 can include internet protocol (IP) networks, such as intranet, a local-area network, a wide-area network, a virtual private network (VPN), a Wi-Fi network, a short-range wireless network (e.g. Bluetooth or Bluetooth Low Energy), the internet, or combinations of the above. The communication links 130 can be direct links, or links that traverse one or more networks, including both local and wide-area networks.

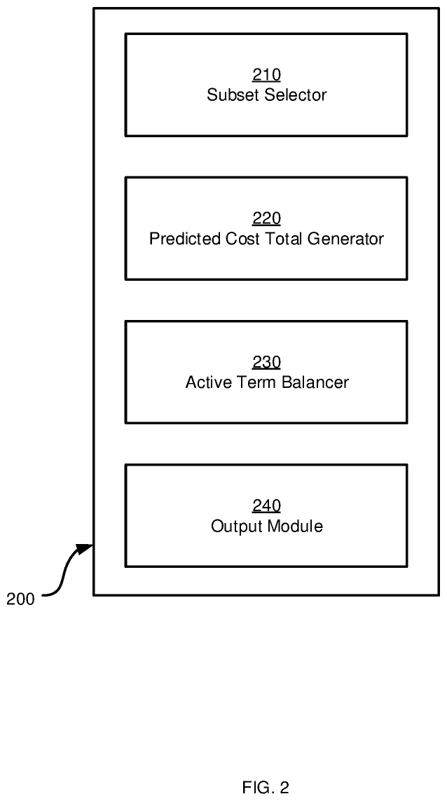

Turning now to FIG. 2, certain subcomponents of the control application 200 are shown. The control application 200 includes a subset selector 210 configured to obtain active term data and select a subset of active terms based on the active term data, a predicted cost total generator 220 configured to obtain price data and generate a predicted cost total, an active term balancer 230 configured to modify active term data based on discrepancies, and an output module 240 configured to output the predicted cost total.

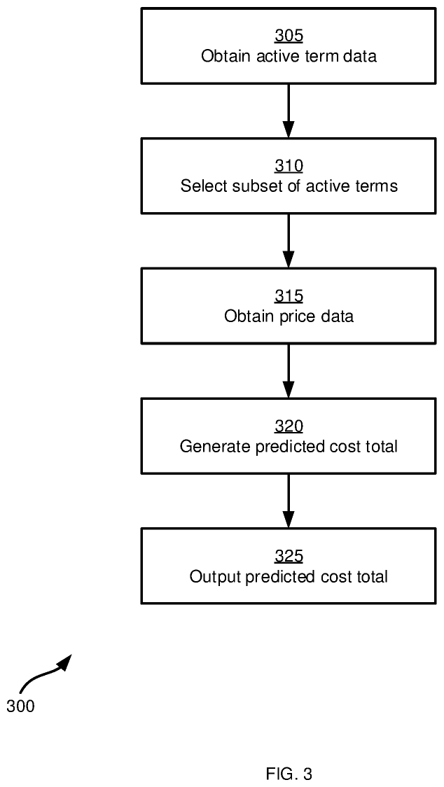

The functionality of the system 100, as implemented via execution of the application 200 by the processor 112 will now be described in greater detail, with reference to FIG. 3. FIG. 3 illustrates a method 300 of workload forecasting. The method 300 will be described in conjunction with its performance in the system 100, and in particular by the processor 112, with reference to the components illustrated in FIGS. 1 and 2.

At block 305, the processor 112, and particularly the subset selector 210 is configured to obtain, from the docketing database 116, active term data representing active terms. As used herein, “active term data” can include active term attributes (e.g. term date, assigned login ID, case ID, etc.), as well as related case information (e.g. client, registered charge lines, registered active term log lines, team information, etc.). Active term data for a given active term can further include active term attributes and related case information for related terms, as defined in the term definition for the given active term.

At block 310, the processor 112, and particularly the subset selector 210 is configured to select a subset of the active terms based on active term data. The subset selector 210 can select the subset for example based on term date, assigned login ID, client information, or a combination of the above.

For example, to forecast workload for a particular individual, the subset selector 210 can select the subset based on the assigned login ID of the active term. In other examples, an active term may represent a primary action item deadline (e.g. filing a patent application, assigned to a supervising team member), with related terms representing subtasks for that action item (e.g. drafting the patent application, assigned to a working team member). Accordingly, the subset selector 210 can select a subset based on the assigned login ID of the related terms to forecast the workload for the team member performing the work. Alternately, the subset selector 210 can select the subset based on the team information defined in the case information associated with the active term.

In some examples, the subset selector 210 can select the subset based on the term date. The selected subset therefore represents action items which require completion prior to a given date (e.g. within a one-month period). In other examples, the subset can be selected based on related term attributes. The subset can for example, represent potential incoming work (e.g. the related term is directed to obtaining instructions to proceed with the action item) or materialized work requiring completion (e.g. the related term is directed to completing a subtask for the action item).

At block 315, the processor 112, and particularly the predicted cost total generator 220 is configured to obtain, from the docketing database, price data associated with active terms in the subset selected at block 310. As used herein, price data represents a cost of performing the action item associated with the active term. The price data, therefore, can include a tariff for completing the action item, a time value for completing the action item or other quantitative value representing the cost of completing the action item associated with the work code.

In particular, at block 315, the price data is obtained by the generator 220 from the docketing database via a direct look-up to price data stored in the database 116. Accordingly, the processor 112 has an increased efficiency in obtaining the price data, due to the reduced operational burden of processing historical data and computing trends to provide potential price data.

At block 320, the processor 112, and particularly the predicted cost total generator 220 is configured to generate the predicted cost total based on the price data obtained at block 315. More particularly, the predicted cost total can be a sum of the action item subtotals for each active term in the subset selected at block 310. The predicted cost total therefore represents an estimated workload for completing the currently uncompleted action items logged in the docketing system 100.

In some examples, the action item subtotal is the tariff associated with the action item. Accordingly, the generator 220 is configured to sum the tariffs associated with the active terms in the subset selected at block 310 to generate the predicted cost total. In other examples, the action item subtotal can include a discount or a markup for the tariff item, for example, based on client requirements as specified in the client information.

In other examples, the action item subtotal is based on the time value for completing the action item and an average hourly rate. In other examples, the hourly rate can be based on the case information. For example, the hourly rate can be based on assigned login ID of the active term, or related terms. Alternately, the hourly rate can be based on team information associated with the case.

The generator 220 can also be configured, at block 320, to modify the predicted cost total based on the active term data, such as an indicator of completed work. More particularly, the generator 220 can be configured to modify the action item subtotals based on the indicator of completed work for each active term in the subset selected at block 310. The modified predicted cost total therefore represents an estimated workload for completing a remainder of currently uncompleted action items logged in the docketing system 100. That is, the modifications account for subtasks or portions of the action items which have already been completed and hence the modified predicted cost total represents the uncompleted portions to provide a more accurate estimate of workload.

In some examples, the indicator of completed work can be a registered charge line stored in connection with the case and associated with the given active term. More particularly, the charge line may represent a portion of the work (i.e. subtasks) of the action item which have been completed. Accordingly, the generator 220 is configured to subtract the price of the charge line from the action item subtotal. In other examples, the indicator of completed work can be an editable field of the active term data. For example, if the editable field is a percentage value of the status of the action item, the subtotal can be adjusted based on the percentage completion. In further examples, the indicator of completed work can be an active term log line. For example, a registered log line can indicate that a certain subtask has been completed. The generator 220 can be configured to modify the subtotal based on a predefined percentage or portion of the tariff (e.g. if a certain log line is registered, the tariff can be considered 90% complete).

For example, consider an active term for completing the filing of a patent application. The active term may be associated with a work code defining a tariff for completing the filing of a patent application. During the preparation of the patent application for filing, a patent professional may record an indicator of work completed of the patent application (e.g. by registering charge lines, or by updating a percentage completion, or by marking an active term complete to register an active term log line). To accurately estimate future workload, the generator 220 can calculate a price based on the indicator (e.g. by calculating the price of the charge line based on amount of time and hourly rate, by determining the percentage completed of the tariff, or based on a predefined ratio of the tariff) and subtract the calculated price from the tariff.

Thus, the processor 112 can generate the predicted cost total with increased accuracy, as the price data is data driven. Specifically, the price data related to actual active terms registered to cases in the database 116. Further, the predicted cost total is modified by data driven indicators of completed work, registered and stored in the database 116.

At block 325, the processor 112, and particularly the output module 240 is configured to output the predicted cost total. For example, the output module 240 can be configured to generate a report for display at the client device 120 or send an email received at the client device 120 indicating the predicted cost total. In other examples, the output module 240 can be configured to generate a visual representation of the predicted cost total. Other outputs are also contemplated.

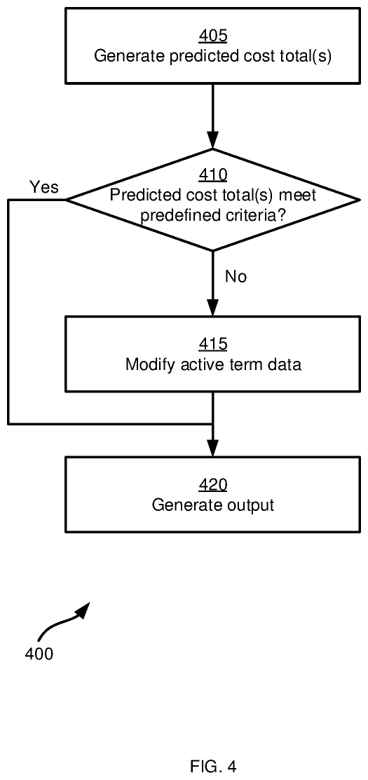

Turning now to FIG. 4, a method 400 of workload distribution is depicted. The method 400 will be described in conjunction with its performance in the system 100, and in particular by the processor 112, with reference to the components illustrated in FIGS. 1 and 2.

At block 405, the processor 112 is configured to generate one or more predicted cost totals, for example by performing the method 300.

At block 410, the processor 112, and particular the active term balancer 230 is configured to determine if the predicted cost totals meet predefined criteria. More generally, the active term balancer 230 evaluates whether the predicted cost totals generated at block 405 represent a suitable workload distribution, as defined by the predefined criteria.

For example, the predefined criteria may specify a minimum and/or maximum threshold value for the predicted cost total. The threshold value can vary based on the subset for the predicted cost total. For example, to balance workload for a particular individual, the threshold value may vary based on the individual's role, experience and the like. In other examples, the threshold value may vary based on the time period of the subset (e.g. term dates within three months, within one year, or for all time).

In other examples, the predefined criteria can specify a balance, or a ratio of a first predicted cost total associated with a first subset of active terms to a second predicted cost total associated with a second set of active terms. For example, to balance workload between two individuals with the same role, capability and experience, the predefined criteria may specify an approximately equal ratio of predicted cost totals (e.g. within 5% of each other). To balance workload between two individuals with different capability or experience, and hence different minimum and maximum threshold values, the predefined criteria may specify an approximately equal percentage capacity (e.g. around 50% between the respective minimum and maximum threshold values).

If the predicted cost total(s) are determined to have met the predefined criteria at block 410, the processor 112 is configured to proceed to block 420, as described further below.

If a discrepancy is detected at block 410, the processor 112 is configured to proceed to block 415. At block 415, the processor 112, and more particularly the active term balancer 230 is configured to modify active term data. For example, the balancer 230 can be configured to modify team information associated with one or more of the active terms in the subset from one team to another team. In other examples, the balancer 230 can be configured to modify assigned login ID of one or more active terms in the subset from one individual to another individual.

The active term balancer 230 can be configured to modify the active term data based on distribution rules for maintaining a desired distribution of work. For example, the distribution rules can specify active term data modifications to rectify the discrepancy detected at block 410 (e.g. to achieve an approximately equal ratio of predicted cost totals between two individuals). The distribution rules can be defined in consideration of other predicted cost totals than those generated at block 405. For example, when modifying active term data to distribute work across between individuals over a three-month period, the distribution rules can additionally consider the predicted cost totals for those individuals over a six-month and one-year period to avoid overcorrection and increase consistency.

In other examples, the distribution rules can be defined in consideration of indicators of completed work. In other words, active terms having an indicator of completed work may not be modified to allow the same individual or team to complete the action item. In further examples, the distribution rules can be defined in consideration of case information, such as the contact information, to increase consistency. For example, all cases having the same contact information may be assigned to the same team to provide consistency in interactions. Other distribution rules, including combinations of the above, are also contemplated.

At block 420, the processor 112, and particularly the output module 240 is configured to generate an output. For example, the output can be a report, or an email notification, or the like. In particular, the output can specify the results of the comparison of the predicted cost totals to the predefined criteria, as well as any active term data modifications.

The present disclosure provides a system for workload forecasting and distribution. In particular, workload forecasting is calculated based on objective data, including active terms registered in the docketing database and predefined price data stored in the database. The system can therefore operate more efficiently, reducing operational burden on the server due to a reduced need to obtain historical data and perform additional computations based on the historical data. Further, the server may more efficiently distribute work based on data indicative of actual workload, with a reduced reliance on subjective opinions of individuals.

The scope of the claims should not be limited by the embodiments set forth in the above examples, but should be given the broadest interpretation consistent with the description as a whole.

1. A method in a processor of a docketing system comprising:
obtaining, from a docketing database of the docketing system, active term data defining active terms, the active terms representing action items in the docketing system;
selecting a subset of the active terms based on the active term data;
obtaining, from the docketing database, price data associated with active terms in the subset, the price data representing a cost of performing the action items associated with the active terms;
generating a predicted cost total based on the price data; and
outputting the predicted cost total.

2. The method of claim 1, wherein the active term data includes one or more of: term date and assigned login ID.

3. The method of claim 1, further comprising modifying the predicted cost total based on an indicator of completed work.

4. The method of claim 3, wherein the indicator comprises a registered charge line associated with an active term in the subset.

5. The method of claim 3, wherein the indicator comprises an editable field of the active term data.

6. The method of claim 3, wherein the indicator comprises a registered log line associated with an active term in the subset.

7. The method of claim 1, wherein the outputting includes one or more of: generating a report; and sending an email.

8. The method of claim 1, further comprising:
detecting a discrepancy between the predicted cost total and a predefined threshold value; and
generating a notification based on the discrepancy.

9. The method of claim 1, further comprising
detecting a discrepancy between the predicted cost total to a second predicted cost total associated with a second subset of the active terms; and
modifying the active term data based on the discrepancy.

10. A docketing system comprising:
a memory storing a docketing database; and
a processor connected to the memory, the processor configured to:
obtain, from the docketing database, active term data defining active terms, the active terms representing action items in the docketing system;
select a subset of the active terms based on the active term data;
obtain, from the docketing database, price data associated with active terms in the subset, the price data representing a cost of performing the action items associated with the active terms;
generate a predicted cost total based on the price data; and
output the predicted cost total.

11. The system of claim 10, wherein the active term data includes one or more of: term date and assigned login ID.

12. The system of claim 10, wherein the processor is further configured to modify the predicted cost total based on an indicator of completed work.

13. The system of claim 12, wherein the indicator comprises a registered charge line associated with an active term in the subset.

14. The system of claim 12, wherein the indicator comprises an editable field of the active term data.

15. The system of claim 12, wherein the indicator comprises a registered log line associated with an active term in the subset.

16. The system of claim 10, wherein the processor is configured to output the predicted cost total by one or more of: generating a report; and sending an email.

17. The system of claim 10, wherein the processor is further configured to:
detect a discrepancy between the predicted cost total and a predefined threshold value; and
generate a notification based on the discrepancy.

18. The system of claim 10, wherein the processor is further configured to:
detect a discrepancy between the predicted cost total to a second predicted cost total associated with a second subset of the active terms; and
modify the active term data based on the discrepancy.
